(19) United States
(12) Patent Application Publication
(10) Pub. No.: US 2025/0307813 A1
(43) Pub. Date: Oct. 2, 2025

(54) EFFICIENT AND PRIVACY PRESERVING RESOURCE INTERACTION

(71) Applicant: Visa International Service Association, San Francisco, CA (US)

(72) Inventors: Pradnesh Kulkarni, Newark, CA (US); Tony England, Tega Cay, SC (US); Gang Kane Zhou Rao, San Francisco, CA (US)

(73) Assignee: Visa International Service Association, San Francisco, CA (US)

(21) Appl. No.: 19/092,249

(22) Filed: Mar. 27, 2025

Related U.S. Application Data
(60) Provisional application No. 63/571,235, filed on Mar. 28, 2024.

(51) Int. Cl. G06Q 20/40; G06Q 20/42; G06Q 50/06

(52) U.S. Cl. CPC G06Q 20/40; G06Q 20/42; G06Q 50/06

(57) ABSTRACT

A method is disclosed. The method includes receiving, from a storage application server, a data packet comprising access data. The method also includes receiving, from a transport computer, a request for the data packet, after the transport computer receives a message comprising a value and a resource provider identifier from a resource provider computer. The method further includes transmitting, to the transport computer, a response comprising the data packet. The transport computer is programmed to receive the data packet, generate an authorization request message comprising the access data, the resource provider identifier, and the value, and transmit the authorization request message to an external computer for authorization processing.

### CROSS-REFERENCE TO RELATED APPLICATIONS

This application is a non-provisional application of, and claims the benefit of, U.S. Provisional Application No. 63/571,235, filed on Mar. 28, 2024, which is herein incorporated by reference in its entirety.

### BACKGROUND

Storage applications such as wallet applications on user devices or their associated storage application servers can store access data such as credentials or tokens. The access data can be passed to a resource provider in a transaction, and the resource provider can obtain authorization for the transaction using the access data.

One problem with this type of interaction is that the access data is passed to the resource provider. If the resource provider behaves fraudulently, they can obtain the access credentials to conduct unauthorized transactions. Further, a computer system operated by the resource provider that stores such access data can be subjected to hacking and man-in-the middle attacks. Such attacks can compromise the access data. Still further, to improve the security of their systems, the resource provider may need to be PCI-DSS (payment card industry data security standard) complaint. Compliance with this standard can require significant modifications to computer hardware and software. This is particularly burdensome for the resource provider.

Additionally, in the context of charging electrical vehicles, a growing number of electric charging stations are able to supply electricity to vehicles that are not of the same brand as the electric charging stations. Those electric vehicles may have associated storage applications for access data, but there is no easy way to pass the access data in those storage applications to the electric charging stations, since the electric charging stations were designed to charge vehicles of the same brand as the electric charging stations. As such, a problem of interoperability exists with respect to storage applications that are not managed by the same brand or organization as the charging stations.

Further, some electric charging systems can allow the storage application servers to initiate transactions for recharging vehicles instead of the resource providers that operate the electric charging stations. However, such systems do not allow the resource provider to initiate and control the transactions that are conducted with their charging stations. This is undesirable from the perspective of the resource provider.

Embodiments of the invention address these and other problems, individually and collectively.

### BRIEF SUMMARY

One embodiment of the invention includes a method. The method includes receiving, by an orchestrator computer from a storage application server, a data packet comprising access data; receiving, by the orchestrator computer from a transport computer, a request for the data packet, after the transport computer receives a message comprising a value and a resource provider identifier from a resource provider computer; and transmitting, by the orchestrator computer to the transport computer, a response comprising the data packet, wherein the transport computer is programmed to receive the data packet, generate an authorization request message comprising the access data, the resource provider identifier, and the value, and transmit the authorization request message to an external computer for authorization processing.

Another embodiment of the invention comprises an orchestrator computer comprising: a processor; and a computer readable medium, the computer readable medium comprising code, executable by the processor, for performing a method comprising: receiving, from a storage application server, a data packet comprising a credential or a token; receiving, from a transport computer, a request for the data packet, after the transport computer receives a message comprising a value and a resource provider identifier from a resource provider computer; and transmitting, to the transport computer, a response comprising the data packet, wherein the transport computer is programmed to receive the data packet, generate an authorization request message comprising the access data, the resource provider identifier, and the value, and transmit the authorization request message to an external computer for authorization processing.

Another embodiment of the invention includes a method comprising: receiving, by a transport computer from a resource provider computer, a message comprising a value and a resource provider identifier; transmitting, by a transport computer to an orchestrator computer, a request for a data packet comprising a credential or a token; receiving, by the transport computer, a response comprising the data packet; generating, by the transport computer, an authorization request message comprising the access data, the resource provider identifier, and the value; and transmitting, by the transport computer, the authorization request message to an external computer for authorization processing.

Another embodiment of the invention includes a transport computer. The transport computer comprises a processor, and a computer readable medium. The computer readable medium comprises code, executable by the processor for implementing a method comprising: receiving, from a resource provider computer, a message comprising a value and a resource provider identifier; transmitting, to an orchestrator computer, a request for a data packet comprising a credential or a token; receiving a response comprising the data packet; generating an authorization request message comprising the access data, the resource provider identifier, and the value; and transmitting the authorization request message to an external computer for authorization processing.

These and other embodiments are described in further detail below.

### BRIEF DESCRIPTION OF THE DRAWINGS

FIG. 1 shows a block diagram of a system according to an embodiment.

FIG. 2 shows a block diagram of components in a vehicle according to an embodiment.

FIG. 3 shows a block diagram of an energy supply terminal according to an embodiment.

FIG. 4 shows a block diagram of an orchestrator computer according to an embodiment.

FIG. 5 show a block diagram of a user device according to an embodiment.

FIG. 6 shows a block diagram of a transport computer according to an embodiment.

FIG. 7 shows a block diagram showing a network processing computer according to an embodiment.

FIG. 8 shows a flow diagram illustrating a transaction flow according to an embodiment.

FIGS. 9A-9B show a flow diagram illustrating a process flow according to another embodiment.

### DETAILED DESCRIPTION

A “user” may include an individual. In some embodiments, a user may be associated with one or more personal accounts and/or mobile devices. The user may also be referred to as a cardholder, account holder, or consumer in some embodiments.

A “user device” may be a device that is operated by a user. Examples of user devices may include a mobile phone, a smart phone, a card, a personal digital assistant (PDA), a laptop computer, a desktop computer, a server computer, a vehicle such as an automobile, a thin client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment.

“Access data” may include any suitable data that can be used to access a resource or create data that can access a resource. In some embodiments, access data may be account information for a payment account. Account information may include a PAN, payment token, expiration date, card verification values (e.g., CVV, CVV2), dynamic card verification values (dCVV, dCVV2), token cryptograms, transaction cryptograms, etc. In other embodiments, access data could include data that can be used to access a location or to access secure data. Such information may be ticket information for an event, data to access a building, transit ticket information, passwords, biometrics or other credentials to access secure data, etc.

“Credentials” may comprise any evidence of authority, rights, or entitlement to privileges. For example, access credentials may comprise permissions to access certain tangible or intangible assets, such as a building or a file. Examples of credentials may include passwords, passcodes, or secret messages. In another example, payment credentials may include any suitable information associated with and/or identifying an account (e.g., a payment account and/or payment device associated with the account). Such information may be directly related to the account or may be derived from information related to the account. Examples of account information may include an “account identifier” such as a PAN (primary account number or “account number”), a token, a subtoken, a gift card number or code, a prepaid card number or code, a user name, an expiration date, a CVV (card verification value), a dCVV (dynamic card verification value), a CVV2 (card verification value 2), a CVC3 card verification value, etc. An example of a PAN is a 16-digit number, such as “4147 0900 0000 1234”.

A “token” can include a substitute identifier for some information. For example, an interaction token may include an identifier for an interaction account that is a substitute for an account identifier, such as a primary account number (PAN). For instance, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing transaction processing networks (e.g., ISO 8583 financial transaction message format). In some embodiments, a token may be a random string of characters. In some embodiments, a token may be used in place of a PAN to initiate, authorize, settle or resolve a transaction. The token may also be used to represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” can include a process by which data is replaced with substitute data. For example, an account identifier (e.g., a primary account number (PAN)) may be tokenized by replacing the account identifier with a substitute number (e.g., a token) that is associated with the account identifier. Further, tokenization may be applied to other information which may be replaced with a substitute value. Tokenization may be used to enhance transaction efficiency, improve transaction security, increase service transparency, or to provide a method for third-party enablement.

A “token service provider” can include an entity including one or more server computers that generates, processes, and/or maintains tokens. A token service provider may include or be in communication with a token vault where the generated tokens are stored. Specifically, the token vault may maintain one-to-one mapping between a token and the credential (e.g., a real account identifier) represented by the token.

An “authorization request message” may be an electronic message that requests authorization for an interaction. In some embodiments, it is sent to a transaction processing computer and/or an issuer of a payment card to request authorization for a transaction. An authorization request message according to some embodiments may comply with International Organization for Standardization (ISO) 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a payment token, a username, an expiration date, etc. An authorization request message may also comprise “transaction information,” such as any information associated with a current transaction, such as the transaction value, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g., POS equipment) that indicates approval of the transaction. The code may serve as proof of authorization.

An “authorizing entity” may be an entity that authorizes a request. Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer, or in some embodiments, a portable device.

A “resource provider” may be an entity that can provide a resource such as goods, services, information, energy (e.g., electricity), and/or access. Examples of resource providers includes merchants, data providers, transit agencies, governmental entities, venue and dwelling operators, etc. A resource provider can operate a resource provider computer. Examples of resource provider computers can include merchant computers, energy supply terminals, access devices such as POS terminals, energy supply operator computers, etc.

A “network processing computer” may include a server computer used for interaction processing. In some embodiments, the network processing computer may be coupled to a database and may include any hardware, software, other logic, or combination of the preceding for servicing the requests from one or more client computers. The network processing computer may comprise one or more computational apparatuses and may use any of a variety of computing structures, arrangements, and compilations for servicing the requests from one or more client computers. In some embodiments, a network processing computer may include data processing subsystems, networks, and operations used to support and deliver authorization services, exception file services, and clearing and settlement services. An exemplary network processing computer may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system, which performs clearing and settlement services. The network processing computer may use any suitable wired or wireless network, including the Internet.

The network processing computer may process interaction-related messages (e.g., authorization request messages and authorization response messages) and determine the appropriate destination computer (e.g., an issuer computer) for the interaction-related messages. In some embodiments, the network processing computer may authorize interactions on behalf of an issuer. The network processing computer may also manage and/or facilitate the clearing and settlement of interactions. In some cases, the network processing computer can include a token service computer, which can perform tokenization and/or de-tokenization services as described above.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

An “application” may be computer code or other data stored on a computer readable medium (e.g., memory element or secure element) that may be executable by a processor to complete a task.

An “storage application” can be an application that can stores data such as credentials or tokens. One example of a storage application is a digital wallet or digital wallet application. A storage application can perform functions other than data storage. For example, a storage application can include programming to control or operate a vehicle, communicate with server computers, authenticate users, etc.

A “digital wallet” can include an electronic device that allows an individual to conduct electronic commerce transactions. A digital wallet may store user profile information, payment credentials, bank account information, one or more digital wallet identifiers and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like. A digital wallet may be designed to streamline the purchase and payment process. A digital wallet may allow the user to load one or more payment cards onto the digital wallet so as to make a payment without having to enter an account number or present a physical card.

A “digital wallet provider” may include an entity, such as an issuing bank or third party service provider, which issues a digital wallet to a user that enables the user to conduct financial transactions. A digital wallet provider may provide standalone user-facing software applications that store account numbers, or representations of the account numbers (e.g., payment tokens), on behalf of a cardholder (or other user) to facilitate payments at more than one unrelated merchant, perform person-to-person payments, or load financial value into the digital wallet. A digital wallet provider may enable a user to access its account via a personal computer, mobile communication device or access device.

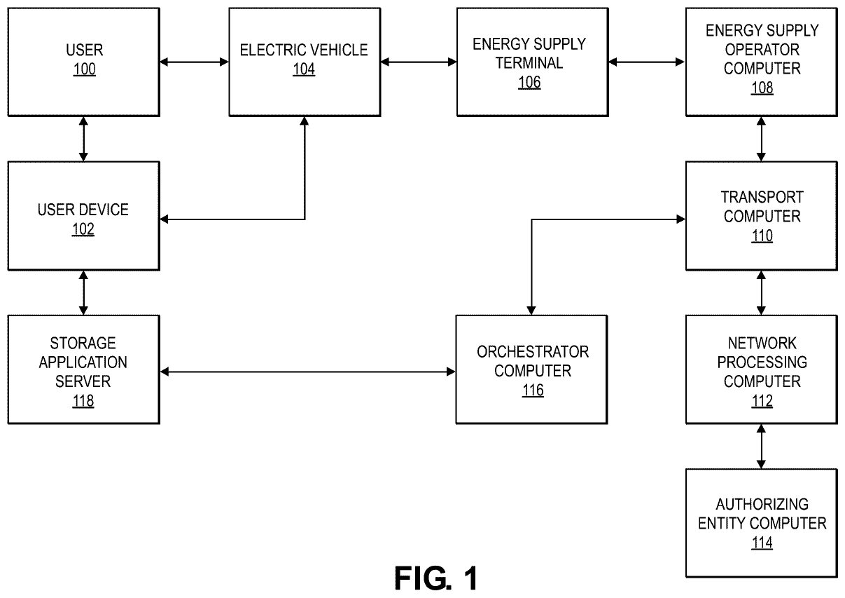

FIG. 1 shows a block diagram of a system according to an embodiment. FIG. 1 shows a user 100 that can operate a user device 102 and an electric vehicle 104 (e.g., an electric car). The user device 102 and/or the electric vehicle 104 may have a storage application which may be managed by a storage application server 118. The storage application server 118 may be remotely located with respect to the user device 102.

FIG. 1 also shows an energy supply terminal 106 can be an electric charging terminal or electric charging station. The energy supply terminal 106 can supply energy (e.g., electricity) to the electric vehicle 104, via an electrical or other means. The energy supply terminal 106 may be one of many energy supply terminals that are in communication with an energy supply operator computer 108, which may be a backend server computer. In some embodiments, the energy supply terminal 106 and the energy supply operator computer 108 may be operated or managed by one entity (e.g., Tesla™), while the storage application server 118 and/or the electric vehicle 104 may be produced or managed by another entity (e.g., Ford™) or other entities. The energy supply operator computer 108 may be in communication with a transport computer 110 via an Internet or other type of connection. The transport computer may be in communication with an authorizing entity computer 114 via a network processing computer 112. The transport computer 110 and the storage application server 118 can be in communication with an orchestrator computer 116. In some embodiments, the network processing computer 112 and the orchestrator computer 116 may be operated by the same entity.

The electrical components (e.g., the computers) in the system of FIG. 1 and any of the following figures can be in operative communication with each other through any suitable communications medium 150. Suitable examples of the communications medium 150 may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices of FIG. 1 may be transmitted using a secure communications protocol such as, but not limited to, File Transfer Protocol (FTP); HyperText Transfer Protocol (HTTP); ISO 8583, WebSockets; and Secure Hypertext Transfer Protocol (HTTPS).

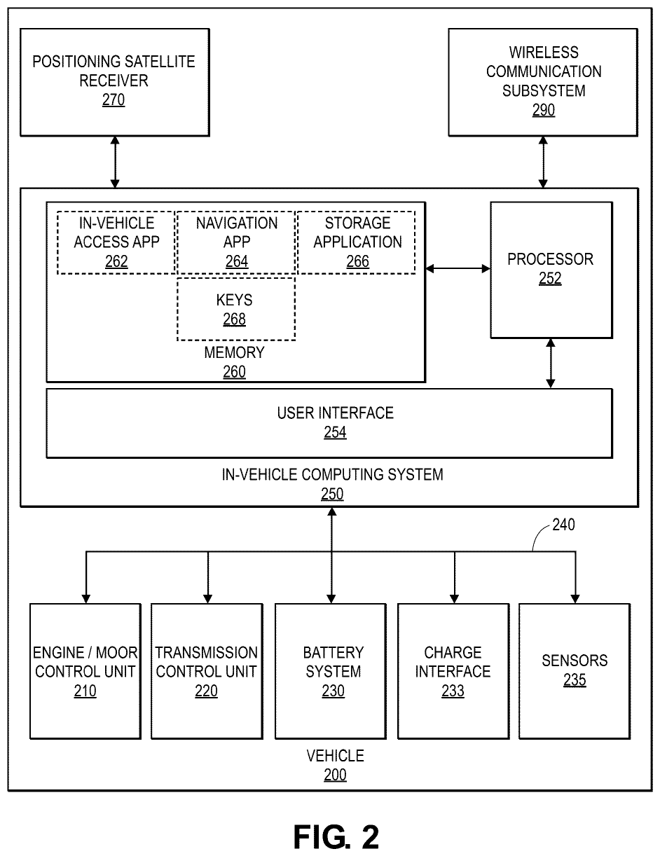

FIG. 2 shows a block diagram of components in a vehicle 200 according to an embodiment. Vehicle 200 can be, for example, an electric vehicle (e.g., an electric car) like the electric vehicle 104 in FIG. 1. Although vehicle 200 may be described as an automobile, it should be understood that in some embodiments, the techniques described herein can also be applied to other types of vehicles such as motorcycles, boats, aircrafts, or other types of powered machines that are used to transport a user from one location to another.

Vehicle 200 may include various electronic control units (ECUs) to operate and control the electrical system or other subsystems of vehicle 200, and may include sensors 235 that the ECUs can monitor. Each ECU may include a microcontroller and one or more memories (e.g., any combination of SRAM, EEPROM, Flash memories, etc.) to store one or more executable programs for the ECU. Examples of ECUs may include engine/motor control unit 210, transmission control unit 220, etc. In some embodiments, vehicle 200 may include additional ECU(s) not specifically shown, omit one or more ECUs, and/or integrate any of the functionalities of different ECUs into a single ECU.

Vehicle 200 can also include a battery system 230 comprising one or more batteries and a charge interface 232 for charging the one or more batteries. The battery system 230 and the charge interface 233 can be in communication with and coupled to the in-vehicle computing system 250 and its processor 252.

Engine/motor control unit 210 may control the actuators, valves, motor, and/or other components of the engine of vehicle 200, or an electric motor of the vehicle 200. Transmission control unit 220 may control the gear shifting and the transmission modes (e.g., park, drive, neutral, reverse) of vehicle 200. Battery system 230 may include electronics that can control the electrical voltage and current supplied by its one or more batteries to the various components of vehicle 200. Sensors 235 may include vehicle speed sensors (e.g., wheel sensors) to detect the speed of vehicle 200, temperature sensors to detect the operating temperature of the vehicle's various components, air sensors to detect oxygen level in the engine, sensors to detect the amount of energy currently (e.g., electricity, gas, etc.) present with the vehicle or the available capacity of any energy storage devices such batteries, cameras to observe the surroundings of vehicle 200, etc. The various ECUs, devices, and sensors may communicate with one another via a vehicle communication bus. Examples of vehicle communication bus may include a controller area network (CAN) bus, a local interconnect network (LIN) bus, a vehicle area network (VAN) bus, or other suitable signal buses for vehicle communication.

Vehicle 200 may also include various radio frequency (RF) transceivers to allow vehicle 200 to receive and transmit RF signals with other devices. For example, vehicle 200 may include a positioning satellite receiver 270 such as a GPS receiver to receive satellite signals that can be demodulated and decoded to determine the location of vehicle 200. The positioning satellite receiver 270 can be used by a positioning or navigation subsystem of vehicle 200 to perform routing and mapping functions.

Vehicle 200 may also include a wireless communication subsystem 290 to enable network connectivity for vehicle 200. Wireless communication subsystem 290 may include one or more wireless transceivers that use WiFi, WiMax, or other types of wireless network communication protocols to connect vehicle 200 to an external network (e.g., the Internet) such that vehicle 200 can communicate with remote servers. Wireless communication subsystem 290 may also include one or more short or near range wireless transceivers such as RFID, Bluetooth or Bluetooth Low Energy, NFC, beacon, infrared transmitters and/or receivers that can be used to communicate with an access device in proximity to vehicle 200.

Vehicle 200 may also include an in-vehicle computing system 250 with which a user of vehicle 200 can interact. In-vehicle computing system 250 can be an infosystem, infotainment system, or other instrumentation system. In-vehicle computing system 250 can be mounted in the center console, dashboard, rear console, or other locations in vehicle 200 that is convenient for a user to access the in-vehicle computing system 250. In some embodiments, in-vehicle computing system 250 can be coupled to vehicle communication bus to receive vehicle status information from the ECUs and sensors 235.

In-vehicle computing system 250 may include a processor 252, a memory 260, and user interface 254. User interface 254 may include an input interface such as any number of buttons, knobs, microphone and/or a touchscreen that can receive user input, and an output interface such as a display (may be part of a touchscreen) and/or speakers. The display of user interface 254 can be integrated with the housing of in-vehicle computing system 250, or can be a separate component coupled to in-vehicle computing system 250 but mounted at a different location than in-vehicle computing system 250. For example, the display of user interface 254 can be mounted on the surface of the center console, on the dashboard, on the surface of the rear console, behind the headrest, on the interior ceiling, on the visor, or other suitable location in vehicle, and may display various types of information including information such as vehicle status information (e.g., speed, fuel economy, engine temperature, etc.), environmental information (e.g., inside/outside temperature, weather, etc.), navigation information (e.g., maps, routes, places of interests, etc.), entertainment such as videos or titles of audio selections or radio stations, energy level information (e.g., amount of charge present and needed to fill to capacity, amount of gas present and needed to fill to capacity), transaction information, energy terminal information, etc.

Memory 260 may include any combination of SRAM, DRAM, EEPROM, Flash, and/or other types of memories, etc. Memory 260 may store a number of applications such as an in-vehicle access application 262, a navigation application 264, a storage application 266, and cryptographic keys 268.

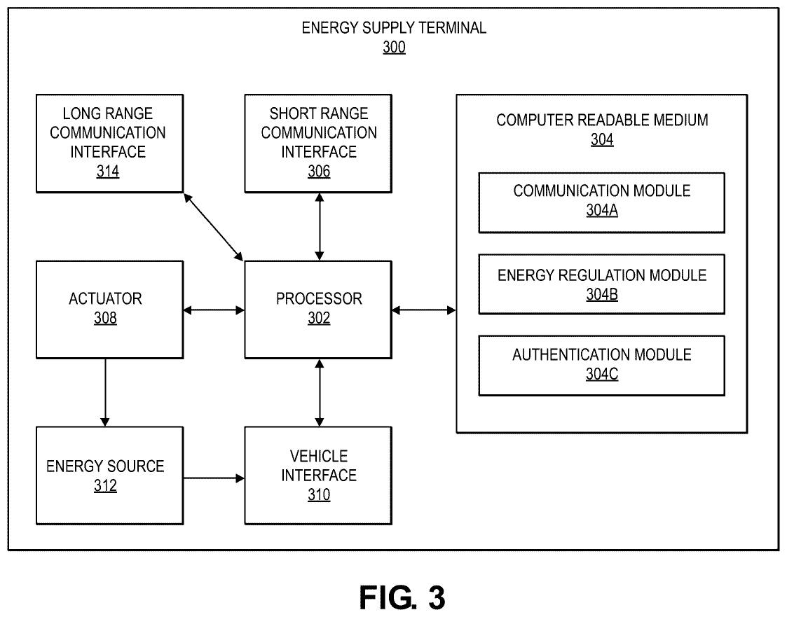

FIG. 3 shows a block diagram of an energy supply terminal 300 according to an embodiment. It can be similar to the energy supply terminal 106 in FIG. 1. The energy supply terminal 300 can comprise a processor 302 and a computer readable medium 304. It can also comprise a short range communication interface 306, an actuator 308, a vehicle interface 310, and a long range communication interface 314 coupled to the processor 302. An energy source 312 can be coupled to the actuator 308 and the vehicle interface 310. The actuator 308 may be a pump or switch (e.g., an electrical or mechanical switch) that allows the energy source 312 to provide energy to the vehicle interface 310 and then to a connected vehicle. The energy source 312 could be an electrical line or conduit (connected to a power supply), battery, or fuel tank.

The computer readable medium 304 may further comprises a communication module 304A, an energy regulation module 304B, and an authentication module 304C. The communication module 304A can include code, executable by the processor 302 to allow the energy supply terminal 80 to communicate with external devices such as a vehicle or remote computer such as the previously described terminal support computer 70. The energy regulation module 3048 and the processor 302 can determine how much energy is needed or should be provided to a vehicle, and can control the actuator 308 to control the flow of energy to the vehicle interface 310 and to the connected vehicle. The authentication module 304C can be used to authenticate a user and/or a vehicle that may be connected to the energy supply terminal 80.

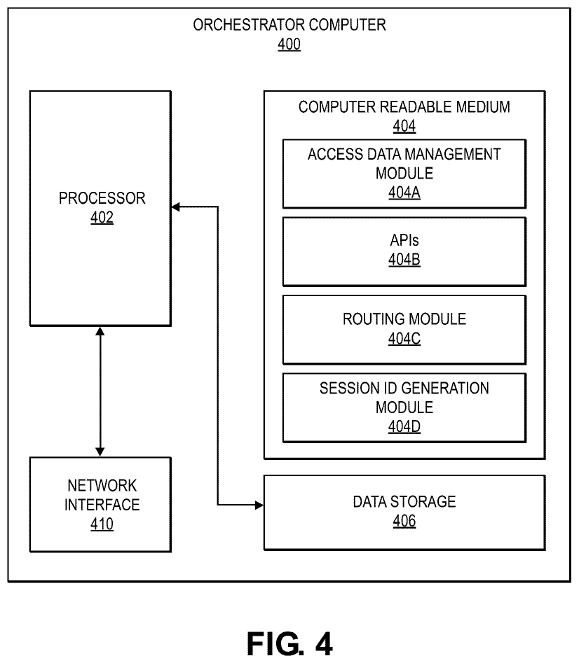

FIG. 4 shows a block diagram of an orchestrator computer 400 according to an embodiment. The orchestrator computer 400 can be similar to the orchestrator computer 116 in FIG. 4. It may comprise a processor 402. The processor 402 may be coupled to a computer readable medium 404, a data storage 406, and a network interface 410. The computer readable medium 404 can comprise various software modules and APIs. The computer readable medium 404 can include an access data management module 404A, APIs 404B, a routing module 404C, and a session ID generation module 404D. The access data management module 404A can, in conjunction with the processor 402, store access data and other associated data (e.g., a session identifier, a resource provider identifier, etc.) that it has received in the data storage 406, and retrieve the access data when it is requested. The APIs may be communication interfaces between external computers such as the transport computer 110, the network processing computer 112, the storage application server 118, etc. in FIG. 1. The routing module 404C, in conjunction with the processor 402, can include network addresses and routing instructions for various external computers such as different storage application servers and different transport computers. The session ID generation module 404D can, in conjunction with the processor 402, generate session identifiers for interactions such as payment transactions. The session ID generation module 404D can use a random number or pseudo-random number generator as an input to an algorithm to generate the session IDs. In some embodiments, the session ID generation module 404D may be additionally or alternatively present in the storage application server 118 in FIG. 1.

The computer readable medium 404 can comprise code, executable by the processor 402, for performing a method comprising: receiving, from a storage application server, a data packet comprising access data; receiving, from a transport computer, a request for the data packet, after the transport computer receives a message comprising a value and a resource provider identifier from a resource provider computer; and transmitting, to the transport computer, a response comprising the data packet, wherein the transport computer is programmed to receive the data packet, generate an authorization request message comprising the access data, the resource provider identifier, and the value, and transmit the authorization request message to an external computer for authorization processing.

The network interface 410 may include an interface that can allow the orchestrator computer 400 to communicate with external computers. The network interface 606 may enable the transport computer 600 to communicate data to and from another device. Some examples of the network interface 606 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 606 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

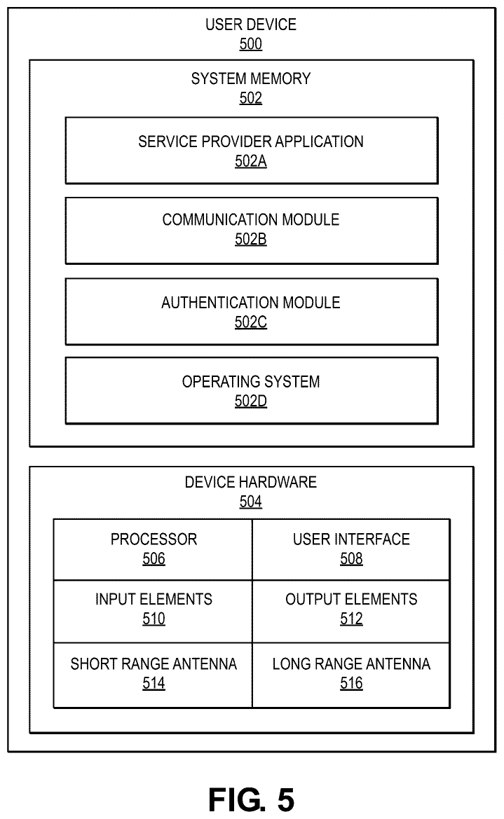

FIG. 5 shows a block diagram of a user device 500 in according to an embodiment. The user device 500 can be similar to the user device 102 in FIG. 1. The user device 500 may include device hardware 504 coupled to a system memory 502.

Device hardware 504 may include a processor 506, a short range antenna 514, a long range antenna 516, input elements 510, a user interface 508, and output elements 512 (which may be part of the user interface 508). Examples of input elements may include microphones, keypads, touchscreens, sensors, etc. Examples of output elements may include speakers, display screens, and tactile devices.

The long range antenna 516 may include one or more RF transceivers and/or connectors that can be used by user device 500 to communicate with other devices and/or to connect with external networks. The user interface 508 can include any combination of input and output elements to allow a user to interact with and invoke the functionalities of user device 500. The short range antenna 514 may be configured to communicate with external entities through a short range communication medium (e.g., using Bluetooth, Wi-Fi, infrared, NFC, etc.). The long range antenna 516 may be configured to communicate with a remote base station and a remote cellular or data network, over the air.

The system memory 502 can be implemented using any combination of any number of non-volatile memories (e.g., flash memory) and volatile memories (e.g., DRAM, SRAM), or any other non-transitory storage medium, or a combination thereof media.

The system memory 502 may also store a storage application 502A, a communication module 502B, an authentication module 502C, and an operating system 502D. The storage application 502A can store access data or can access a storage application server that stores access data. It may also have other functions such as programmed to control an electric vehicle, communicate with the electric vehicle, and to access and lock the electric vehicle. The communication module 502B may comprise code or software, executable by the processor 506, for communicating with other devices. The communication module 502B may be configured or programmed to perform some or all of the functionality associated with receiving, sending, and generating electronic messages for transmission through the user device 500. The authentication module 502C may comprise code, executable by the processor 506, to authenticate a user. This can be performed using user secrets (e.g., passwords) or user biometrics.

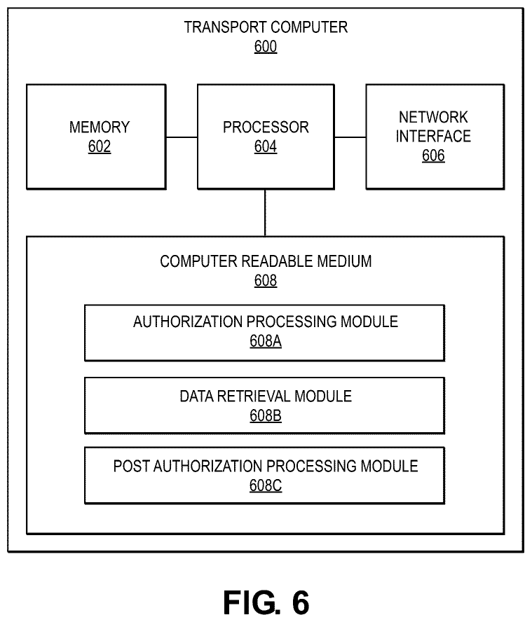

FIG. 6 shows a block diagram of a transport computer 600 according to an embodiment. The transport computer 600 can be similar to the transport computer 110 in FIG. 1. The exemplary transport computer 600 comprises a processor 604. The processor 604 may be coupled to a memory 602, a network interface 606, and a computer readable medium 608. The computer readable medium 608 can comprise modules. The computer readable medium 608 can include an authorization processing module 608A, a data retrieval module 608B, and a post authorization processing module 608C. The authorization processing module 608A, in conjunction with the processor 604, can perform authorization processing. Authorization process can include generating and routing authorization request message to one or more processing network computers and/or authorizing entity computers. The data retrieval module 608B, in conjunction with the processor, can retrieve and store data in the memory 602. The post authorization processing module 608C, in conjunction with the processor, can perform post authorization processing such as clearing and settlement processing.

The memory 602 can be used to store data and code. The memory 602 can also include one or more databases of information. For example, the memory 602 can store interaction data (transaction data), access data, routing tables, user rules, resource provider rules, etc. The memory 602 may be coupled to the processor 604 internally or externally (e.g., cloud based data storage), and may comprise any combination of volatile and/or non-volatile memory, such as RAM, DRAM, ROM, flash, or any other suitable memory device.

The computer readable medium 608 may comprise code, executable by the processor 604, for performing a method comprising: receiving, from a resource provider computer, a message comprising a value and a resource provider identifier; transmitting, to an orchestrator computer, a request for a data packet comprising a credential or a token; receiving a response comprising the data packet; generating an authorization request message comprising the access data, the resource provider identifier, and the value; and transmitting the authorization request message to an external computer for authorization processing.

The network interface 606 may include an interface similar to network interface 410 in FIG. 4, and the descriptions thereof are incorporated herein.

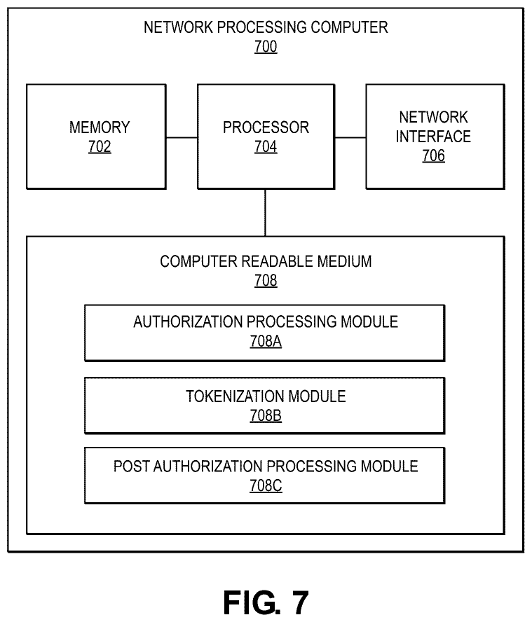

FIG. 7 shows a block diagram showing a network processing computer according to an embodiment. The exemplary network processing computer 700 may comprise a processor 704. The processor 704 may be coupled to a memory 702, a network interface 706, and a computer readable medium 708. The computer readable medium 708 can comprise modules. The computer readable medium 708 can include an authorization processing module 708A, a tokenization module 708B, and a post authorization processing module 708C. The network processing computer 700 can be in operative communication with a database 710. The authorization processing module 708A, in conjunction with the processor 704, can perform authorization processing. Authorization process can include generating and routing authorization request message to one or more transport computers and/or authorizing entity computers. The tokenization module 708B, in conjunction with the processor 704, can perform token processing such as de-tokenization, re-tokenization, cryptogram verification, etc. The post authorization processing module 708C, in conjunction with the processor, can perform post authorization processing such as clearing and settlement processing.

The memory 702 can be used to store data and code. For example, the memory 702 can store interaction data, access data (e.g., tokens, credentials, cryptograms, etc.) routing tables, etc. The memory 702 may be coupled to the processor 704 internally or externally (e.g., cloud based data storage), and may comprise any combination of volatile and/or non-volatile memory, such as RAM, DRAM, ROM, flash, or any other suitable memory device.

The network interface 706 may include an interface (similar to or different than network interface 410 in FIG.) that can allow the network processing computer 700 to communicate with external computers.

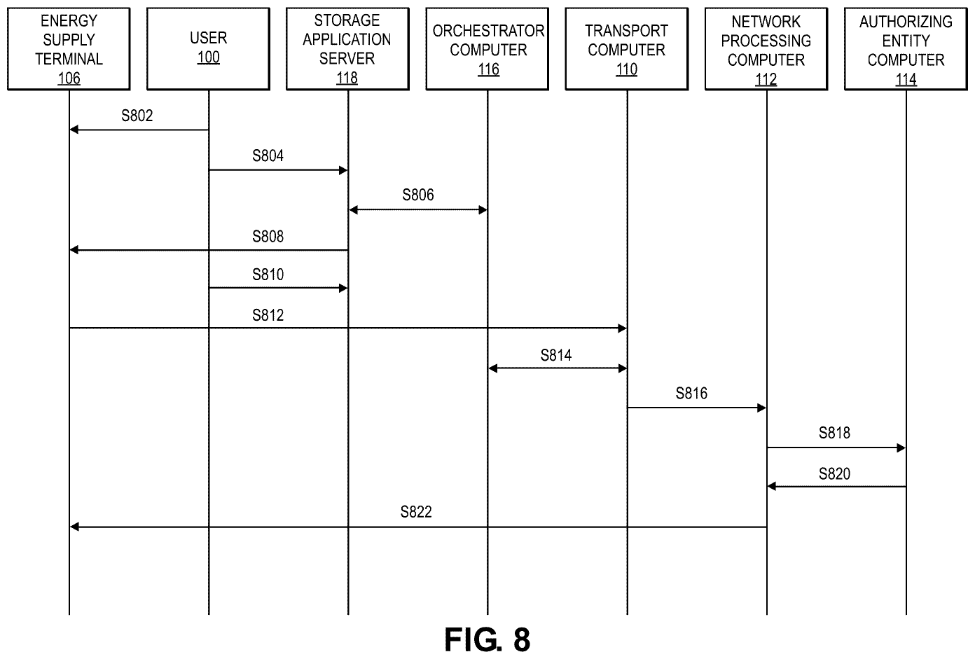

FIG. 8 shows a flow diagram illustrating a transaction flow for a charging transaction involving a current authorization request message according to an embodiment. The current authorization request message may be considered a final authorization request message for charging and electric vehicle. FIG. 8 shows an energy supply terminal 106, a user 100, a storage application server 118, an orchestrator computer 116, a transport computer 110, a network processing computer 112, and an authorizing entity computer 114. Each of these components is described above.

FIG. 8 is described in the context of a user 100 that wishes to charge their electric vehicle (104 in FIG. 1) at the energy supply terminal 106, which may be an electric charging terminal.

In step S802, the user 100 may drive an electric vehicle close to the energy supply terminal 106. The user connects (e.g., plugs) a charging cable associated with the energy supply terminal 106 into their electric vehicle.

In step S804, the user 100 initiates a charging process using a storage application associated with the storage application server 118. The storage application may be on the user's user device (e.g., 102 in FIG. 1), which may be a mobile phone. The storage application could alternatively or additionally be on the electric vehicle. The storage application may be an OEM (original equipment manufacturer) application associated with the electric vehicle. In this case, the storage application can have other functions such as the ability to monitor the performance of the electric vehicle and/or to control the electric vehicle (e.g., access the vehicle).

In step S806, before, during, or after charging, the storage application server 118 can transmit a data packet comprising access data of the user 100 that is stored on the storage application server 118 or on the corresponding storage application on the user's user device or electric vehicle, to the orchestrator computer 116. The storage application server 118 and the orchestrator computer 116 can communicate with each other via one or more APIs. The access data may include a token or credential, an expiry date, and a cryptogram. Also, in step S806, storage application server may transmit a resource provider identifier (e.g., in the data packet) to the orchestrator computer 116. The resource provider identifier can include any suitable information that can identify a resource provider. In this example, the resource provider identifier could be an identifier (e.g., a name, or identification number) associated with the energy supply terminal 106 and/or a corresponding energy supply operator computer (108 in FIG. 6) and/or the entity that operates the energy supply terminal 106 and the energy supply operator computer. The orchestrator computer 116 can store the access data and the resource provider identifier in the data packet in a database along with a session identifier that identifies the charging session. In some embodiments, the storage application server 118 can generate the session identifier and send it to the orchestrator computer 116. In other embodiments, the orchestrator computer 116 can generate the session identifier and send it to the storage application server 118.

In step S808, the storage application server 118 then communicates with the energy supply terminal 106 to start the charging session. The storage application server 118 can communicate with the energy supply terminal 106 via the storage application on the user's ser device or the electric vehicle. The energy supply terminal 106 can communicate with the electric vehicle through the charging cable in the energy supply terminal 106 or via a wireless communication mechanism such as Bluetooth™, Wi-Fi™, etc. The electric vehicle, in turn, can be in communication the user device of the user and also the storage application on the user device. The storage application server 118 can transmit the session identifier to the energy supply terminal 108 via the storage application.

In step S810, after the charging of the electric vehicle is completed, the storage application server 118 is informed by the storage application on the electric vehicle or the user device that the charging has been completed.

In step S812, the energy supply terminal 106 or the energy supply operator computer associated with the energy supply terminal 106 can then transmit a message comprising a value (e.g., a cost) associated with the electricity obtained by the electric vehicle from the energy supply terminal 106, a resource provider identifier, and the session identifier, to the transport computer 110. The value may be an amount (e.g., a monetary amount) associated with the electricity obtained by the electric vehicle from the energy supply terminal 106 during the charging session. In some embodiments, the amount may be a final amount for the charging transaction.

In step S814, after receiving the message in step S812, the transport computer 110 can fetches the data packet from the orchestrator computer 116 by transmitting a request for the data packet to the orchestrator computer 116. The request for the data packet may include the session identifier that was received from the energy supply terminal 106. The orchestrator computer 116 can search a database using the session identifier to locate the access data stored in step S806.

In step S816, the transport computer 110 can generate a current authorization request message comprising the access data, the resource provider identifier, and the value, and transmit the authorization request message to an external computer for authorization. The external computer can be the network processing computer 112 and/or the authorizing entity computer 114. If the access data comprises the credential such a primary account number associated with a credit or debit account, then the authorization request message may be transmitted to the authorizing entity computer 114 via the network processing computer 112 (steps S816 and S818). If the access data comprises the token, then the network processing computer 112 can detokenize the token to obtain the credential associated with the token. The network processing computer 112 can also validate any token cryptogram that is present in the the authorization request message to include the credential and can transmit the modified authorization request message to the authorizing entity computer 114 in step S818.

In step S820, the authorizing entity computer 114 can determine whether or not the transaction is authorized by analyzing the authorization request message. The authorizing entity computer 114 can then generate and transmit an authorization response message to the network processing computer 112.

In step S822, the network processing computer 112 can transmit the authorization response message back to the transport computer 110, which can then send it to the energy supply terminal 106 or an energy supply operator computer.

At the end of the day or other period of time, a clearing and settlement process can occur between the transport computer 110, the network processing computer 112, and the authorizing entity computer 114.

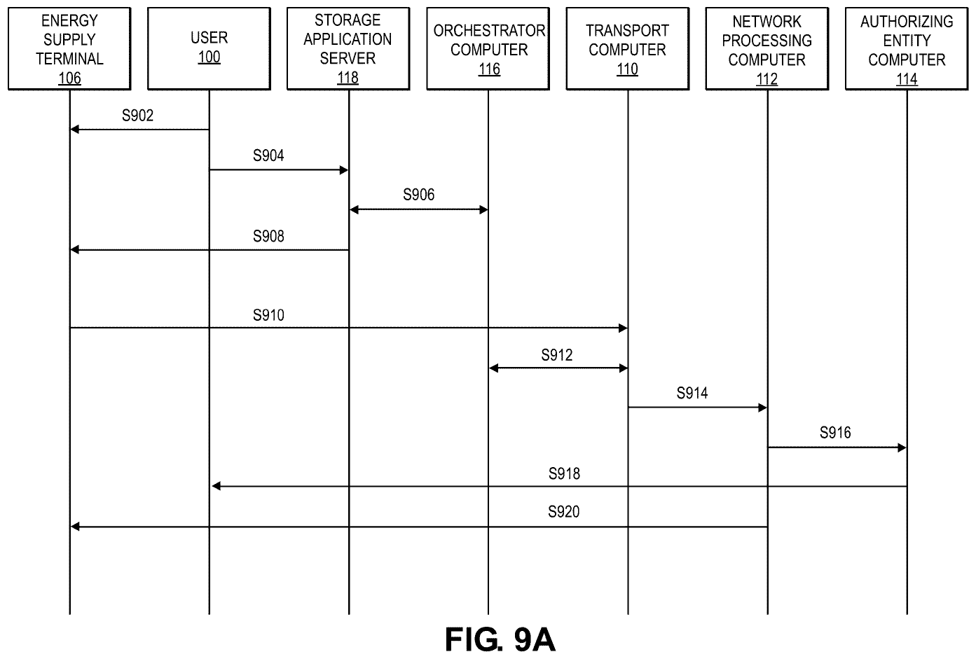

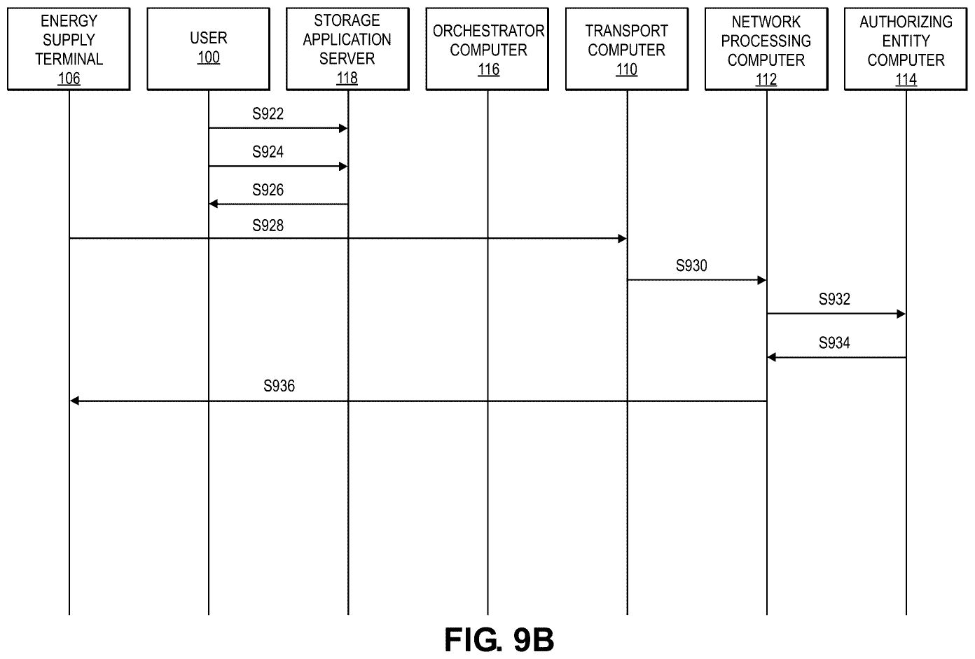

FIGS. 9A-9B show a flow diagram illustrating a transaction flow for a charging transaction involving a pre-authorization request message according to an embodiment. In some embodiments, the entity operating the energy supply terminal may wish to ensure that the user has sufficient funds or credit to pay for the electricity obtained during charging session before electricity is provided to the electric vehicle. Otherwise, the electricity could be provided, but the user may have insufficient funds to pay for the provided electricity.

Steps S902, S904, S906, and S908 can be similar to steps S802, S804, S806, and S808 in FIG. 8, and the descriptions thereof are incorporated herein.

In step S910, the energy supply terminal 106 or the energy supply operator computer associated with the energy supply terminal 106 can initiate a pre-authorization process. The pre-authorization process can be initiated by transmitting a message comprising a value (e.g., a cost) associated with an estimated amount of the electricity to be obtained by the electric vehicle from the energy supply terminal 106 or a set amount that would be sufficient to pay for a full charge of the electric vehicle, a resource provider identifier, and the session identifier, to the transport computer 110. In some embodiments, the value may be a pre-authorization amount for the charging transaction.

In step S912, after receiving the message in step S910, the transport computer 110 can fetches the data packet from the orchestrator computer 116 by transmitting a request for the data packet to the orchestrator computer 116. The request may include the session identifier. The orchestrator computer 116 can locate the access data stored in a database in step S806 using the session identifier.

In step S914, the transport computer 110 can generate a pre-authorization authorization request message comprising the access data, the resource provider identifier, and the value, and transmit the pre-authorization request message to an external computer for authorization. The external computer can be the network processing computer 112 and/or the authorizing entity computer 114. If the access data comprises the credential such a primary account number associated with a credit or debit account, then the authorization request message may be transmitted to the authorizing entity computer 114 via the network processing computer 112 (steps S914 and S916). If the access data comprises the token, then the network processing computer 112 can detokenize the token to obtain the credential associated with the token. The network processing computer 112 can also validate any cryptogram that is present in the authorization request message. The network processing computer 112 can then modify the authorization request message to include the credential and can transmit the modified authorization request message to the authorizing entity computer 114 in step S916.

In step S918, the authorizing entity computer 114 can approve of the transaction, validate any cryptogram in the authorization request message, and can place a hold on the account of the user for the value.

In step S920, the authorizing entity computer 114 can then generate and transmit an authorization response message to the energy supply terminal 106 or the energy supply operator computer via the transport computer 110 and the network processing computer 112.

In step S922, the user tracks the charging of the electric vehicle in the storage application on the user device or the electric vehicle of the user. The storage application server 118 may be in communication with the storage application.

In step S924, the charging of the electric vehicle is completed, and the storage application server 118 is informed that the charging has been completed.

In step S926, an indication that charging is completed and transaction data for the charging transaction are displayed to the user via the storage application on the user device or the electric vehicle. The transaction data may include the time and date of the charging session, the amount of electricity obtained, and cost of charging the electric vehicle.

In step S928, the energy supply terminal 106 or the energy supply operator computer associated with the energy supply terminal 106 can generate and transmit a message comprising a value associated with the actual amount of electricity obtained by the electric vehicle from the energy supply terminal 106, a resource provider identifier, and the session identifier, to the transport computer 110.

In step S930, after receiving the message including the resource provider identifier and the session identifier from the energy supply terminal 106, the transport computer 110 can generate a final authorization request message including the access data, the resource provider identifier, and the value, and transmit the authorization request message to an external computer for authorization. The access data may have been stored by the transport computer 110 in a database along with the session identifier in step S914. The access data may be retrieved at this step using the session identifier, and then placed in the final authorization request message. The external computer can be the network processing computer 112 and/or the authorizing entity computer 114. If the access data comprises the credential such a primary account number associated with a credit or debit account, then the authorization request message may be transmitted to the authorizing entity computer 114 via the network processing computer 112 (steps S930 and S932). If the access data comprises the token, then the network processing computer 112 can detokenize the token to obtain the credential associated with the token. The network processing computer 112 can also validate any cryptogram that is present in the the authorization request message to include the credential and can transmit the modified authorization request message to the authorizing entity computer 114 in step S932.

If the authorizing entity computer 114 approves of the transaction, the prior hold on the account in the pre-authorization process is released.

In step S920, the authorizing entity computer 114 can review the final authorization request message and determine if the transaction should or should not be authorized (e.g., based on the credit or balance of an account corresponding to the credential). The authorizing entity computer 114 can then generate and transmit an authorization response message to the energy supply terminal 106 or the energy supply operator computer via the transport computer 110 and the network processing computer 112.

At the end of the day or other period of time, a clearing and settlement process can occur between the transport computer 110, the network processing computer 112, and the authorizing entity computer 114.

Embodiments of the invention have a number of advantages. Embodiments of the invention allow transactions to be conducted efficiently, but in a privacy preserving manner. For example, as illustrated by the embodiments of the invention, a resource provider computer such as an energy supply terminal and/or an energy supply operator computer do not obtain a user's sensitive access data during a transaction. As such, the resource provider computer need not be PCI-DSS compliant. Communications between entities such as the transport computer, the network processing computer and the authorizing entity computer are more secure than resource provider computers since they are often already PCI-DSS compliant. Further, embodiments of the invention allow for storage applications which are not affiliated with the resource provider computers (e.g., an energy supply terminal or an energy supply terminal computer) to conduct transactions with access data. Thus, embodiments of the invention can allow devices to be interoperable where interoperability would otherwise be difficult to achieve.

It should be understood that any of the embodiments can be implemented in the form of control logic using hardware (e.g., an application specific integrated circuit or field programmable gate array) and/or using computer software with a generally programmable processor in a modular or integrated manner. As user herein, a processor includes a multi-core processor on a same integrated chip, or multiple processing units on a single circuit board or networked. Based on the disclosure and teachings provided herein, a person of ordinary skill in the art will know and appreciate other ways and/or methods to implement embodiments using hardware and a combination of hardware and software.

Any of the software components or functions described in this application may be implemented as software code to be executed by a processor using any suitable computer language such as, for example, Java, C, C++, C# or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the disclosure. However, other embodiments may be directed to specific embodiments relating to each individual aspect, or specific combinations of these individual aspects.

For the purposes of explanation, specific details are set forth in order to provide a thorough understanding of the exemplary embodiments. However, it will be apparent that various embodiments may be practiced without these specific details. For example, circuits, systems, algorithms, structures, techniques, networks, processes, and other components may be shown as components in block diagram form in order not to obscure the embodiments in unnecessary detail.

The above description is illustrative and is not restrictive. Many variations will become apparent to those skilled in the art upon review of the disclosure. The scope should, therefore, be determined not with reference to the above description, but instead should be determined with reference to the pending claims along with their full scope or equivalents.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by an orchestrator computer from a storage application server, a data packet comprising access data;
receiving, by the orchestrator computer from a transport computer, a request for the data packet, after the transport computer receives a message comprising a value and a resource provider identifier from a resource provider computer; and
transmitting, by the orchestrator computer to the transport computer, a response comprising the data packet, wherein the transport computer is programmed to receive the data packet, generate an authorization request message comprising the access data, the resource provider identifier, and the value, and transmit the authorization request message to an external computer for authorization processing.

2. The method of claim 1, wherein the authorization request message is a pre-authorization request message.

3. The method of claim 1, wherein the authorization request message is a current authorization request message.

4. The method of claim 1, wherein the resource provider computer is an energy supply terminal or an energy supply operator terminal.

5. The method of claim 4, wherein the energy supply terminal is an electrical charging terminal, and the storage application server manages a storage application on a user device or a vehicle.

6. The method of claim 5, wherein the data packet is received by the orchestrator computer after a user initiates a charging session between the vehicle and the electrical charging terminal.

7. The method of claim 1, wherein the external computer is an authorizing entity computer, the authorizing entity computer being programmed to analyze the authorization request message, generate an authorization response message, and transmit the authorization response message to the transport computer.

8. The method of claim 7, wherein the external computer is a network processing computer.

9. The method of claim 8, wherein the access data comprises a token, the token being a substitute for a credential, and wherein the network processing computer is programmed to receive the authorization request message comprising the token, de-tokenize the token to obtain the credential, and transmit the authorization request message comprising the credential, the resource provider identifier to the authorizing entity computer for authorization.

10. The method of claim 1, wherein the orchestrator computer and the storage application server communicate via one or more APIs.

11. An orchestrator computer comprising:
a processor; and
a computer readable medium, the computer readable medium comprising code, executable by the processor, for performing a method comprising:
receiving, from a storage application server, a data packet comprising access data;
receiving, from a transport computer, a request for the data packet, after the transport computer receives a message comprising a value and a resource provider identifier from a resource provider computer; and
transmitting, to the transport computer, a response comprising the data packet, wherein the transport computer is programmed to receive the data packet, generate an authorization request message comprising the access data, the resource provider identifier, and the value, and transmit the authorization request message to an external computer for authorization processing.

12. The orchestrator computer of claim 11, wherein the orchestrator computer comprises a data storage for storing the data packet and other data packets.

13. The orchestrator computer of claim 12, wherein the data packet comprises a session identifier.

14. The orchestrator computer of claim 13, wherein the request for the data packet comprises the session identifier, and the method further comprises:
retrieving the data packet using the session identifier.

15. The orchestrator computer of claim 11, wherein the orchestrator computer comprises one or more APIs for communicating with the storage application server and the transport computer.

16. A method comprising:
receiving, by a transport computer from a resource provider computer, a message comprising a value and a resource provider identifier;
transmitting, by the transport computer to an orchestrator computer, a request for a data packet comprising access data;
receiving, by the transport computer, a response comprising the data packet;
generating, by the transport computer, an authorization request message comprising the access data, the resource provider identifier, and the value; and
transmitting, by the transport computer, the authorization request message to an external computer for authorization processing.

17. The method of claim 16, wherein the message and the request for the data packet further comprises a session identifier.

18. The method of claim 16, wherein the authorization request message is an a pre-authorization request message.

19. The method of claim 16, wherein the access data comprises a credential.

20. The method of claim 16, wherein the external computer is a network processing computer or an authorizing entity computer.
